(19) United States
(12) Patent Application Publication
(10) Pub. No.: US 2026/0316361 A1
(43) Pub. Date: Oct. 15, 2026

(54) Vacuum-Pressure-Gelation Tool for Casting a Casting Material Onto a Component, System and Process for Casting

(71) Applicant: Bayerische Motoren Werke Aktiengesellschaft, Muenchen (DE)

(72) Inventors: Peter SCHMID, Olching (DE); Alexander SCHMIDT, Muenchen (DE)

(21) Appl. No.: 19/484,016

(22) PCT Filed: May 7, 2024
(86) PCT No.: PCT/EP2024/062583

§ 371 Date: Nov. 13, 2025

(30) Foreign Application Priority Data
Jun. 6, 2023 (DE) 102023114758.7

(51) Int. Cl. B29C 45/77; B29C 45/14; B29C 45/58; B29C 45/74; B29L 31/30

(52) U.S. Cl. CPC B29C 45/77; B29C 45/14344; B29C 45/586; B29C 45/74; B29C 2945/76006; B29C 2945/76254; B29C 2945/76545; B29C 2945/76658; B29L 2031/30

(57) ABSTRACT

A vacuum-pressure gelation tool for casting a casting material onto a component includes a casting mold, a nozzle mount, a connecting line, and a conveying device. The component is placeable into the casting mold. The connecting line fluidically connects the nozzle mount to the casting mold and thereby the casting material is led from the nozzle mount to the casting mold and the casting material is vacuum-diecast onto the component. The casting material is conveyable in the connecting line via the conveying device.

### BACKGROUND AND SUMMARY

The present disclosure relates to a vacuum-pressure gelation tool for casting a casting material onto a component, a system for vacuum-pressure gelation and a method for casting a casting material onto a component by means of a system for vacuum-pressure gelation.

WO 2020/043381 A1 discloses a tool for overmolding or encapsulating rotors. The overmolding, encapsulation or casting is carried out here by means of a casting method, in particular by means of vacuum-pressure gelation. Here, a two-component thermosetting plastic, in particular resin and hardener, separately, is prepared under vacuum and the material mixture is introduced from below into an arrangement space, gelled in the mold with the application of pressure and cured.

Furthermore, DE 10 2019 128 499 A1 discloses a method for determining the dosing volume for the overmolding, potting or encapsulation of a component. To fix a rotor to a current-excited synchronous machine, the latter is inserted into a mold or cavity and overmolded or encapsulated with potting compound. The rotor is hereby fixed in particular by means of vacuum-pressure gelation.

It is an object of the present disclosure to devise a solution which permits particularly time-efficient vacuum-pressure gelation of a plurality of components.

This and other objects are achieved by the subject of this disclosure. Further possible refinements of the disclosure are also disclosed in the disclosure, and the figures. Advantages and possible configurations which are illustrated within the context of the description for one of the subjects of the independent claims are to be viewed at least analogously as features, advantages and possible configurations of the respective subject of the other independent claims and any possible combination of the subjects of the independent claims, if appropriate in conjunction with one or more of the subordinate claims.

The disclosure relates to a vacuum-pressure gelation tool for casting a casting material onto a component. In particular, by means of the vacuum-pressure gelation tool, a resin is cast onto the component as casting material or the component is encapsulated by means of the casting material. The vacuum-pressure gelation tool comprises a casting mold into which the component can be placed. Furthermore, the vacuum-pressure gelation tool comprises a nozzle mount, onto which a casting nozzle can be docked, whereby the casting material can be put into the vacuum-pressure gelation tool via the docked casting nozzle. In other words, the casting material is provided by the casting nozzle and put into the vacuum-pressure gelation tool via the nozzle mount. After the casting material has been put into the vacuum-pressure gelation tool via the nozzle mount by means of the casting nozzle, the casting nozzle can be detached from the nozzle mount and removed. As a result, the casting nozzle can be used for filling a further vacuum-pressure gelation tool with the casting material. In this way, by means of one casting nozzle, a particularly large number of vacuum-pressure gelation tools can be filled with the casting material within a particularly short time interval.

The vacuum-pressure gelation tool also comprises a connecting line which fluidically connects the nozzle mount to the casting mold, whereby the casting material can be fed from the nozzle mount to the casting mold, and whereby the casting material is vacuum-diecast onto the component. In order to avoid undesired voids or holes of a potting material arising on the component because of a volume shrinkage of the casting material during curing, the vacuum-pressure gelation tool comprises a conveying device, by means of which the casting material can be conveyed in the connecting line. This means that the conveying device is designed to continue to convey the casting material in the connecting line and thus to continue to force it into the casting mold. By means of the conveying device, it is possible to ensure that the casting material is continuously under pressure in the casting mold during the curing, in that the casting material arranged in the connecting line is forced in the direction of the casting mold by means of the conveying device and thus continues to be conveyed.

During the vacuum-pressure gelation, the casting material, in particular a casting resin, is subject to chemically induced shrinkage during curing, which can lead to shrinkage voids and cracks. Provision is therefore made for the casting material to be cured under pressure. During the curing, casting material continues to be pressed in continuously in order to compensate for the shrinkage. Particularly short curing times can be achieved hereby. During vacuum-pressure gelation, the casting material is pressed into the casting mold under pressure and this pressure is maintained during the curing of the casting material in the casting mold. Consequently, the casting mold must be designed to be particularly stable with respect to pressure. During vacuum-pressure gelation, a vacuum is applied to the casting mold in order to achieve bubble-free casting of the casting material onto the component. Since an absolute vacuum is technically not feasible, a residual pressure of a few mbar can prevail in the casting mold during casting. If bubbles form in the casting mold during the casting of the casting material, then these are virtually completely compressed when the vacuum is broken. Bubbles which may possibly occur are compressed to a particularly small volume during the venting to atmospheric pressure. Within the context of the vacuum-pressure gelation, the casting material can thus be cast onto the component in a particularly bubble-free manner, whereby particularly short curing times can be achieved.

Usually, during the curing of the casting material, the pressure of the casting material in the casting mold would be maintained by continuing to press in casting material by means of the casting nozzle. However, the casting nozzle must be retained on the vacuum-pressure gelation tool for this purpose and cannot be used for filling a further vacuum-pressure gelation tool during the curing. The vacuum-pressure gelation tool described makes it possible for the casting material in the casting mold to cure reliably with the application of pressure without the casting nozzle having to continue to press the casting material into the vacuum-pressure gelation tool during the entire during process. Instead, the casting nozzle can be detached from the vacuum-pressure gelation tool after the casting material has been put into the vacuum-pressure gelation tool and can be used for the filling of a further vacuum-pressure gelation tool with the casting material. The vacuum-pressure gelation tool described makes it possible for a plurality of vacuum-pressure gelation tools to be particularly efficiently supplied with casting material by means of a single casting nozzle.

In a possible development of the disclosure, provision is made for the conveying device to comprise a plunger guided in the connecting line, by means of which casting material arranged in the connecting line can be conveyed to the casting mold. This plunger is in particular movable translationally in the connecting line in the direction of the extent of the connecting line, whereby the casting material in the connecting line can be forced in the direction of the casting mold by means of the plunger. An external diameter of the plunger corresponds to an internal diameter of the connecting line, by which means the cross section of the connecting line is at least substantially completely covered by the plunger. Consequently, it is possible to ensure that the casting material arranged in the connecting line is reliably forced in the direction of the casting mold by means of the plunger. An escape of the casting material past the plunger while attempts are being made to force the casting material in the direction of the casting mold by means of the plunger can thus be particularly easily avoided.

In a further possible embodiment of the disclosure, provision is made for the vacuum-pressure generation tool to comprise a pressure sensor, which is arranged in the casting mold. By means of the pressure sensor, a pressure of the casting material cast into the casting mound can be ascertained. Furthermore, the conveying device is designed to convey the casting material in the connecting line depending on the determined pressure. The pressure of the casting material in the casting form is thus determined by means of the pressure sensor during vacuum-pressure gelation. Depending on the pressure determined by the pressure sensor, the casting material in the connecting line is conveyed by means of the conveying device in order to establish and maintain a predefined pressure of the casting material in the casting mold. As a result of the interaction of the pressure sensor with the conveying device, it can particularly reliably be ensured that the pressure of the casting material in the casting mound is maintained during the curing of the casting material.

In a further possible embodiment of the disclosure, provision is made for the vacuum-pressure gelation tool to comprise a heater, by means of which casting material arranged in the connecting line can be heated. For example, cooling of the casting material in the connecting line can be prevented by means of the heater. The heater is designed to heat the casting material, whereby fluidity of the casting material can be maintained. In this way, a danger of curing of the casting material in the connecting line and, consequently, blockage of the connecting line can be kept particularly low.

In a further possible embodiment of the disclosure, provision is made for the casting mold to be designed to accommodate a rotor of a traction machine for a motor vehicle, whereby the rotor can be encapsulated, at least in some areas, with a potting compound as casting material by means of the vacuum-pressure gelation tool. The potting compound can firstly be used for electrical insulation of respective areas of the rotor and secondly to ensure particularly good heat transfer in defined areas of the rotor. The particularly good heat transfer because of the potting compound makes it possible for the rotor to be cooled particularly well during operation and, consequently, for the traction machine having the rotor to be operated particularly efficiently. The vacuum-pressure gelation tool is thus designed to encapsulate the rotor with the potting compound as casting material.

The disclosure further relates to a system for vacuum-pressure gelation, having a vacuum-pressure gelation tool as has already been described in connection with the vacuum-pressure gelation tool according to the disclosure. Furthermore, the system comprises a casting nozzle, which is designed to be reversibly connected to the vacuum-pressure gelation tool. Furthermore, the casting nozzle is designed to put the casting material into the vacuum-pressure generation tool when connected to the vacuum-pressure gelation tool. After the casting material has been put into the vacuum-pressure gelation tool and also during the casting of the casting material in the casting mold of the vacuum-pressure gelation tool, the casting nozzle can be detached from the nozzle mount of the vacuum-pressure generation tool, whereby a further vacuum-pressure gelation tool can be filled with the casting material by means of the casting nozzle. In the vacuum-pressure gelation tool, continuing to force casting material into the casting mound during the curing of the casting material can be implemented by means of the conveying device, by means of which the casting material arranged in the connecting line continues to be forced into the casting mold.

The disclosure further relates to a method for casting a casting material onto a component by means of a system as has already been described in connection with the system for vacuum-pressure gelation according to the disclosure. In particular, within the context of the method, a rotor is encapsulated with a potting compound as casting material. In the method, the component is arranged in the casting mold of the vacuum-pressure gelation tool. The casting nozzle is also coupled to the vacuum-pressure gelation tool via the nozzle mount. The casting material is then put into the vacuum-pressure generation tool by means of the casting nozzle. In the method, casting material arranged in the connecting line is conveyed to the casting form by means of the conveying device. As a result of conveying the casting material in the direction of the casting mold by means of the conveying device in the connecting line, volume shrinkage of the casting material in the casting mold because of curing of the casting material can be compensated. In the method, the casting material is thus cast onto the component, in particular the rotor, by vacuum-pressure gelation.

In a possible development of the disclosure, provision is made for the casting material in the connecting line to be conveyed by means of the conveying device after the casting nozzle has been undocked from the nozzle mount. In other words, the casting material arranged in the connecting line is conveyed to the casting mold by means of the conveying device only after the casting nozzle has been detached from the nozzle mount. As long as the casting nozzle is coupled to the nozzle mount, the casting material is forced into the casting mold through the connecting line by continuing to force casting material out of the casting nozzle. In other words, conveying casting material in the connecting line is prevented as long as the casting nozzle is coupled to the nozzle mount. As soon as the casting nozzle has been removed from the nozzle mount, the casting material arranged in the connecting line continues to be pressed by means of the conveying device in order to maintain the pressure in the casting mold, whereby the shrinkage of the casting material during curing can be compensated.

In a further possible embodiment of the disclosure, provision is made for the pressure in the casting mold to be detected by means of a pressure sensor and, by means of the conveying device, for a conveying speed of the casting material in the connecting line to be adjusted in such a way that the pressure of the uncured casting material in the casting mold remains constant until the casting material has completely cured. In other words, the casting material is conveyed in the connecting line depending on the pressure of the casting material in the casting mold, measured by means of the pressure sensor. The casting material in the connecting line is conveyed by means of the conveying device in such a way that a predefined pressure for the casting material in the casting mold can be maintained. Hereby, firstly particularly rapid curing of the casting material in the casting mold can be achieved and, secondly, reliable compensation for the shrinkage of the casting material during forming can be achieved.

Further features of the disclosure can be gathered from the claims, the figures and the figure description. The features and feature combinations mentioned above in the description and the features and feature combinations shown in the figure description and/or on their own in the figures below can be used not only in the respectively specified combination but also in other combinations or on their own without departing from the scope of the disclosure.

In the figures:

### BRIEF DESCRIPTION OF THE DRAWINGS

FIG. 1 is a schematic perspective view of a vacuum-pressure gelation tool for casting a potting compound onto a rotor of a traction machine of a motor vehicle; and

FIG. 2 is a detail of a schematic sectional view of a system comprising the vacuum-pressure gelation tool, which additionally comprises a casting nozzle.

### DETAILED DESCRIPTION OF THE DRAWINGS

In the figures, identical and functionally identical elements are provided with the same reference signs.

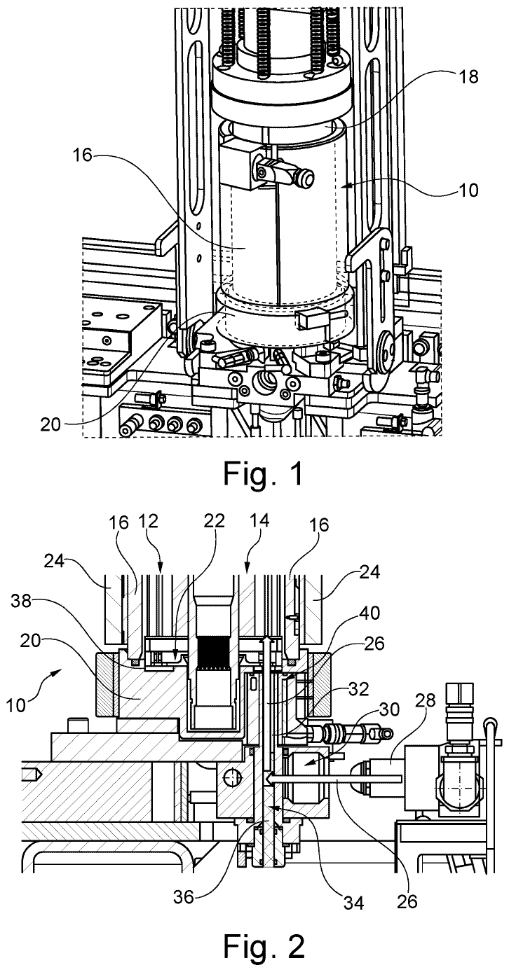

A vacuum-pressure gelation tool 10 is shown in FIG. 1. The vacuum-pressure gelation tool 10 comprises a casting mold 12, in which a component 14 can be placed. In the present case, provision is made for a rotor to be placed in the casting mold 12 as a component 14. The casting mold 12 in the present case is enclosed radially from outside by a bell 16, closed axially upward by an upper core pull 18 and closed radially downward by a lower core pull 20. The lower core pull 20 comprises a lower support plate 22, on which the component 14, in the present case the rotor, is placed, while the component 14 is accommodated in the casting mold 12. The vacuum-pressure gelation tool 10 is shown sectioned in a detail in FIG. 2.

For the thermal insulation of the bell 16, insulating sleeves 24 can be attached radially to the outer circumferential side of the bell 16, by means of which the bell 16 can be thermally insulated. In the present case, the bell 16 can be heated. The casting mold 12 here is at least substantially cylindrical, whereby the rotor arranged in the casting mold 12 as a component 14 can be encapsulated with a casting material 26.

A system for vacuum-pressure gelation is shown in FIG. 2. This system for vacuum-pressure gelation comprises firstly the vacuum-pressure gelation tool 10 and secondly a casting nozzle 28. The casting nozzle 28 is designed to provide the casting material 26 for the vacuum-pressure gelation. The vacuum-pressure gelation tool 10 has a nozzle mount 30, into which the casting nozzle 28 can be plugged. When the casting nozzle 28 is plugged into the nozzle mount 30, the casting material 26 can be put into the vacuum-pressure gelation tool 10 by means of the casting nozzle 28.

In the present case, the casting material 26 is put into a connecting line 32 of the vacuum-pressure gelation tool 10 by means of the casting nozzle 28. The connecting line 32 is fluidically connected to the casting mold 12. This means that the casting material 26 put into the connecting line 32 by the casting nozzle 28 is led via the connecting line 32 to the casting mold 12, in which the component 14, the rotor in the present case, in particular a rotor winding head of the rotor, is encapsulated by means of the casting material 26. For the vacuum-pressure gelation, a particularly low pressure can be established in the casting mold 12, in particular a vacuum can be drawn. The casting material 26 is pressed into the evacuated casting mold 12 under pressure. The fact that the vacuum is established in the casting mold 12 means that the keeping of bubbles by the casting material, for example at respective undercuts, can be avoided particularly well. In order to compensate for volume shrinkage of the casting material 26 occurring during the pressure gelation and curing of the casting material 26, provision is made that during the vacuum-pressure gelation, further casting material 26 continues to be conveyed into the casting mold 12 during the curing of the casting material 26 in the casting mold 12.

In the present case, provision is made for the casting nozzle 28 to be detached from the nozzle mount 30 as soon as a quantity of casting material 26 provided for the vacuum-pressure gelation has been put into the vacuum-pressure gelation tool 10 by means of the casting nozzle 28. The casting nozzle 28 can thus be used for filling a further vacuum-pressure gelation tool 10. In order to ensure that casting material 26 continues to be conveyed into the casting mold 12 during the curing in a situation in which the casting nozzle 28 has already been removed from the vacuum-pressure gelation tool 10, the vacuum-pressure gelation tool 10 comprises a conveying device 34. In the present case, the conveying device 34 comprises a plunger 36. The plunger 36 is movable in the connecting line 32, in particular translationally in the direction of the longitudinal extent of the connecting line 32. By moving the plunger 36 in the connecting line 32, casting material 26 arranged in the connecting line 32 continues to be forced in the direction of the casting mold 12 by the plunger 36. Hereby, firstly a casting pressure can be maintained in the casting mold 12 and, secondly, the volume shrinkage of the casting material 26 during the curing in the casting mold 12 can be compensated.

In the present case, a pressure sensor 38, which is identified schematically by a small box, is arranged in the casting mold 12. The pressure sensor 38 is designed to determine a pressure of the casting material 26 in the casting mold 12. The conveying device 34 is in turn designed to adjust a conveying speed and/or a conveying force by means of which the casting material 26 is conveyed in the connecting line 32, depending on the pressure of the casting material 26 in the casting mold 12 that is measured by means of the pressure sensor 38. In particular, the conveying speed of the casting material 26 in the connecting line 32 is adjusted by means of the conveying device 34 in such a way that the pressure of the uncured casting material 26 in the casting mold 12 remains constant until the casting material 26 has cured completely.

In order to avoid the casting material 26 curing in the connecting line 32, a heater 40 can be provided in the vacuum-pressure gelation tool 10. By means of this heater 40, casting material 26 arranged in the connecting line 32 can be heated. Alternatively or additionally, a sprue can be formed by means of the heater 40. During the casting of the casting material 26, the sprue is a part which does not belong to the molded part. The sprue is produced by casting material 26 that has solidified in the connecting line 32.

The rotor placed in the casting mold 12 as a component 14 can have six holes in each of its mutually opposite end faces. The upper six holes that are at the top in the casting mold 12 are all sealed off during the vacuum-pressure gelation. Of the six holes of the rotor that are arranged at the bottom in the vacuum-pressure gelation tool 10, four are sealed off, the pressure sensor 38 is seated in one of the holes and the casting material 26 is put into the rotor via the last of these holes.

Following the filling operation, the casting nozzle 28 is undocked from the vacuum-pressure gelation tool 10. As a result, subsequent pressure control via pressure monitoring by means of the casting nozzle 28 is not possible. During the filling operation, and thus while the casting nozzle 28 is docked on the vacuum-pressure gelation tool 10, pressure monitoring takes place by means of the pressure sensor 38, which can also be designated as a mold internal pressure sensor. The filling phase via the casting nozzle 28 is carried out under pressure control. After the casting nozzle 28 has been undocked from the vacuum-pressure gelation tool 10, the plunger 36 continues to press on the residual material in the connecting line 32, which can also be designated as a casting shaft, under force/travel control and thus compensates for the material shrinkage in the gelation phase. For this purpose, sensor data from the pressure sensor 38 can be determined and extrapolated. After the casting nozzle 28 has been removed from the vacuum-pressure gelation tool 10, a change is made to plunger control and thus the adjustment of the after-pressure by means of the plunger 36, which can be carried out under force control.

Overall, the disclosure shows how optimization of a control process for vacuum-pressure gelation can be achieved.

### LIST OF REFERENCE SIGNS

10 Vacuum-pressure gelation tool
12 Casting mold
14 Component
16 Bill
18 Upper core pull
20 Lower core pull
22 Support plate
24 Insulating sleeve
26 Casting material
28 Casting nozzle
30 Nozzle mount
32 Connecting line
34 Conveying device
36 Plunger
38 Pressure sensor
40 Heater

1.-9. (canceled)

10. A vacuum-pressure gelation tool for casting a casting material onto a component, comprising:
a casting mold into which the component is placeable;
a nozzle mount, onto which a casting nozzle is docked and whereby casting material is insertable into the vacuum-pressure gelation tool via the docked casting nozzle;
a connecting line, which fluidically connects the nozzle mount to the casting mold and whereby the casting material is led from the nozzle mount to the casting mold and the casting material is vacuum-diecast onto the component; and
a conveying device via which the casting material is conveyable in the connecting line.

11. The vacuum-pressure gelation tool according to claim 10, wherein the conveying device comprises a plunger that is guided in the connecting line and via which casting material arranged in the connecting line is conveyable to the casting mold.

12. The vacuum-pressure gelation tool according to claim 10, further comprising: a pressure sensor that is arranged in the casting mold, via which a pressure of the casting material cast into the casting mold is detectable, wherein the conveying device is configured to convey the casting material in the connecting line based on the determined pressure.

13. The vacuum-pressure gelation tool according to claim 10, further comprising:
a heater that is provided, via which casting material arranged in the connecting line is heatable.

14. The vacuum-pressure gelation tool according to claim 10, wherein the casting mold is configured to accommodate a rotor of a traction machine for a motor vehicle, whereby the rotor is encapsulated in some areas, with a potting compound as casting material via the vacuum-pressure gelation tool.

15. A system for vacuum-pressure gelation, comprising:
a vacuum-pressure gelation tool according to claim 10; and
a casting nozzle which is configured to be connected reversibly to the vacuum-pressure gelation tool and, when connected to the vacuum-pressure gelation tool, is configured to insert the casting material into the vacuum-pressure gelation tool.

16. A method comprising:
casting a casting material onto a component using the system according to claim 15, wherein
the component is arranged in the casting mold;
the casting nozzle is coupled to the vacuum-pressure gelation tool via the further nozzle mount; and
the casting material is inserted into the vacuum-pressure gelation tool via the casting nozzle and casting material arranged in the connecting line is conveyed to the casting mold via the conveying device, whereby volume shrinkage of the casting material on account of curing of the casting material in the casting mold is compensated.

17. The method according to claim 16, wherein the casting material in the connecting line is conveyed via the conveying device after the casting nozzle has been undocked from the nozzle mount.

18. The method according to claim 16, wherein the pressure in the casting mold is detected via a pressure sensor and a conveying speed of the casting material in the connecting line is adjusted via the conveying device in such a way that the pressure of the uncured casting material in the casting mold remains constant until the casting material has completely cured.
